(19) United States
(12) Patent Application Publication
(10) Pub. No.: US 2010/0070678 A1
(43) Pub. Date: Mar. 18, 2010

(54) Saving and Restoring State Information for Virtualized Computer Systems

(75) Inventors: Irene ZHANG, Cambridge, MA (US); Kenneth Charles BARR, Arlington, MA (US); Ganesh VENKITACHALAM, Mountain View, CA (US); Irfan AHMAD, Mountain View, CA (US); Alex GARTHWAITE, Beverly, MA (US); Jesse POOL, Mountain View, CA (US)

Correspondence Address: VMWARE, INC., DARRYL SMITH, 3401 Hillview Ave., PALO ALTO, CA, 94304, US

(73) Assignee: VMWARE, INC., Palo Alto, CA (US)

(21) Appl. No.: 12/559,484

(22) Filed: Sep. 14, 2009

Related U.S. Application Data
(60) Provisional application No. 61/096,704, filed on Sep. 12, 2008.

(51) Int. Cl. G06F 12/00; G06F 9/455

(52) U.S. Cl. 711/6; 718/1; 711/206; 711/E12.001; 711/E12.059

(57) ABSTRACT

Prior to or while the state of a virtual machine (“VM”) is being saved, such as in connection with the suspension or checkpointing of a VM, a set of one or more “active” memory pages is identified, this set of active memory pages comprising memory pages that are in use within the VM before operation of the VM is suspended. This set of active memory pages may constitute a “working set” of memory pages. To restore the state of the VM and resume operation, in some embodiments, (a) access to persistent storage is restored to the VM, device state for the VM is restored, and one or more of the set of active memory pages are loaded into physical memory; (b) operation of the VM is resumed; and (c) additional memory pages from the saved state of the VM are loaded into memory after operation of the VM has resumed.

### CROSS-REFERENCE TO RELATED APPLICATIONS

This applications claims priority of U.S. Provisional Patent Application No. 61/096,704, entitled “Restoring a Checkpointed Virtual Machine”, filed Sep. 12, 2008.

### BACKGROUND OF THE INVENTION

1. Field of the Invention

This invention relates to techniques for saving state information for computer systems, and for later restoring the saved state information and resuming operation of computer systems, including virtualized computer systems.

2. Description of the Related Art

Various issued patents and pending patent applications have discussed methods for storing a “snapshot” or “checkpoint” of the state of a virtual machine (“VM”), so that the operation of the VM can be resumed at a later time from the point in time at which the snapshot or checkpoint was taken. Some embodiments of this invention relate to storing and later restoring the state of a checkpointed VM, so that the VM can resume operation relatively quickly. Techniques of the invention can also be applied to the suspension and resumption of VMs. Also, a person of skill in the art will understand how to implement this invention in an operating system (“OS”) or other system software for the “hibernation” of a conventional, non-virtualized computer system. For simplicity, the following description will generally be limited to storing a checkpoint for a VM, restoring the state of the checkpointed VM and resuming execution of the restored VM, but the invention is not limited to such embodiments.

An issued patent owned by the assignee of this application describes several different types of checkpointing. Specifically, U.S. Pat. No. 6,795,966, entitled “Encapsulated Computer System” (“the '966 patent”), which is incorporated here by reference, describes transactional disks, file system checkpointing, system checkpointing, and application/process-level checkpointing. Each of these techniques provides certain benefits to a computer user, such as the ability to at least partially recover from certain errors or system failures. However, each of these techniques also has significant limitations, several of which are described in the '966 patent. For example, these techniques generally don't provide checkpointing for a complete, standard computer system.

In contrast, the '966 patent discloses a system and method for extracting the entire state of a computer system as a whole, not just of some portion of the memory, which enables complete restoration of the system to any point in its processing without requiring any application or operating system intervention, or any specialized or particular system software or hardware architecture. The preferred embodiment described in the '966 patent involves a virtual machine monitor (“VMM”) that virtualizes an entire computer system, and the VMM is able to access and store the entire state of the VM. To store a checkpoint, execution of the VM is interrupted and its operation is suspended. The VMM then extracts and saves to storage the total machine state of the VM, including all memory sectors, pages, blocks, or units, and indices and addresses allocated to the current VM, the contents of all virtualized hardware registers, the settings for all virtualized drivers and peripherals, etc., that are stored in any storage device and that are necessary and sufficient that, when loaded into the physical system in the proper locations, cause the VM to proceed with processing in an identical manner. After an entire machine state is saved, subsequent checkpoints may be created by keeping a log of changes that have been made to the machine state since a prior checkpoint, instead of saving the entire machine state at the subsequent checkpoint. In the preferred embodiment of the '966 patent, when a subsequent checkpoint is stored, portions of the machine state that are small or that are likely to be entirely changed may be stored in their entirety, while for portions of the machine state that are large and that change slowly a log may be kept of the changes to the machine state.

Another issued patent owned by the assignee of this application also relates to checkpointing a VM, namely U.S. Pat. No. 7,529,897, entitled “Generating and Using Checkpoints in a Virtual Computer System” (“the '897 patent”), which is also incorporated here by reference.

This invention can be used in connection with a variety of different types of checkpointed VMs, including the checkpointed VMs as described in the '966 patent, and including checkpointed VMs that do not involve the storing of the entire state of a computer system. This invention can also be used in connection with checkpointed VMs, regardless of the basic method used to checkpoint the VM.

### SUMMARY OF THE INVENTION

Embodiments of the invention comprise methods, systems and computer program products embodied in computer-readable media for restoring state information in a virtual machine (“VM”) and resuming operation of the VM, the state information having been saved in connection with earlier operation of the VM, the state information for the VM comprising virtual disk state information, device state information and VM memory state information. These methods may comprise: restoring access to a virtual disk for the VM; restoring device state for the VM; loading into physical memory one or more memory pages from a previously identified set of active memory pages for the VM, the set of active memory pages having been identified as being recently accessed prior to or during the saving of the state information of the VM, the set of active memory pages comprising a proper subset of the VM memory pages; after the one or more memory pages from the previously identified set of active memory pages have been loaded into physical memory, resuming operation of the VM; and after resuming operation of the VM, loading into physical memory additional VM memory pages.

In another embodiment of the invention, the previously identified set of active memory pages constitutes an estimated working set of memory pages. In another embodiment, the one or more memory pages that are loaded into physical memory before operation of the VM is resumed constitute the estimated working set of memory pages. In another embodiment, access to the virtual disk is restored before any VM memory pages are loaded into physical memory. In another embodiment, device state for the VM is restored before any VM memory pages are loaded into physical memory. In another embodiment, access to the virtual disk is restored and device state for the VM is restored before any VM memory pages are loaded into physical memory. In another embodiment, after resuming operation of the VM, all of the remaining VM memory pages are loaded into physical memory. In another embodiment, the set of active memory pages for the VM is identified by the following steps: upon determining that state information for the VM is to be saved, placing read/write traces on all VM memory pages that are in physical memory; while state information for the VM is being saved, allowing the VM to continue operating and detecting accesses to VM memory pages through the read/write traces; and identifying VM memory pages that are accessed while state information is being saved as active memory pages. In another embodiment, all memory pages that are accessed while state information is being saved are identified as active memory pages. In another embodiment, the set of active memory pages for the VM is identified by the following steps: (a) upon determining that state information for the VM is to be saved, clearing access bits in page tables for all VM memory pages that are in physical memory; (b) allowing the VM to continue operating and detecting accesses to VM memory pages by monitoring the access bits in the page tables for the VM memory pages; and (c) identifying VM memory pages that are accessed after the access bits were cleared in step (a) as active memory pages. In another embodiment, all memory pages that are accessed after the access bits were cleared in step (a) are identified as active memory pages. In another embodiment, the set of active memory pages for the VM is identified by the following steps: on a continuing basis prior to determining that state information for the VM is to be saved, detecting accesses to VM memory pages; and upon determining that state information for the VM is to be saved, based on the detected accesses to VM memory pages, identifying a set of recently accessed VM memory pages as the set of active memory pages. In another embodiment, accesses to VM memory pages are detected on an ongoing basis by repeatedly clearing and monitoring access bits in one or more shadow page tables. In another embodiment, accesses to VM memory pages are detected on an ongoing basis by repeatedly clearing and monitoring access bits in one or more virtualization-supporting page tables.

### BRIEF DESCRIPTION OF THE DRAWINGS

FIG. 1A illustrates the main components of a virtualized computer system in which an embodiment of this invention is implemented.

FIG. 1B illustrates the virtualized computer system of FIG. 1A after a VM checkpoint has been stored.

FIG. 2A is a flow chart illustrating a general method for generating a checkpoint for a VM, according to one embodiment of this invention.

FIG. 2B is a flow chart illustrating a general method for restoring a VM checkpoint and resuming execution of the VM, according to one embodiment of this invention.

FIG. 2C is a flow chart illustrating steps that may be taken, according to a first embodiment of this invention, to implement steps 806 of FIG. 2A.

FIG. 2D is a flow chart illustrating steps that may be taken, according to a second embodiment of this invention, to implement steps 806 of FIG. 2A.

### DETAILED DESCRIPTION

As described, for example, in the '897 patent, the checkpointing of a VM generally involves, for a particular point in time, (1) checkpointing or saving the state of one or more virtual disk drives, or other persistent storage; (2) checkpointing or saving the VM memory, or other non-persistent storage; and (3) checkpointing or saving the device state of the VM. For example, all three types of state information may be saved to a disk drive or other persistent storage. To restore operation of a checkpointed VM, access to the checkpointed virtual disk(s) is restored, the contents of the VM memory at the time the checkpoint was taken is loaded into physical memory, and the device state is restored. Restoring access to the checkpointed virtual disk(s) and restoring the device state can generally be done quickly. Most of the time required to restore operation of a VM typically relates to loading the saved VM memory into physical memory. Embodiments of this invention relate generally to techniques used to load VM memory into physical memory to enable a VM to resume operation relatively quickly. More specifically, some embodiments of this invention relate to determining a set of checkpointed VM memory pages that are loaded into physical memory first, then operation of the VM is resumed, and then some or all of the remaining VM memory pages are loaded into physical memory. Some embodiments involve determining an order in which units of checkpointed VM memory pages are loaded into physical memory and selecting a point during the loading of VM memory at which operation of the VM is resumed. In some embodiments a set of active memory pages is determined prior to or during the checkpointing of a VM, the active memory pages comprising VM memory pages that are accessed around the time of the checkpointed state. When the checkpointed state is restored into a VM, so that operation of the VM can be resumed, some or all of the active memory pages are loaded into physical memory, operation of the VM is resumed and then some or all of the remaining VM memory pages are loaded into physical memory. Various techniques may be used to restore access to the virtual disk(s), or other persistent storage, of a VM, and various techniques may be used to restore device state for the VM. This invention may generally be used along with any such techniques.

Some experimentation and testing has been performed related to the checkpointing of VMs, followed by the subsequent restoration of the VMs. Different techniques have been tried and measurements have been taken to determine the amount of time it takes for a restored VM to become responsive for a user of the VM.

One possible approach for loading checkpointed VM memory into physical memory involves loading all checkpointed VM memory into physical memory before allowing the VM to resume operation. This approach may involve a relatively long delay before the VM begins operating.

Another possible approach involves allowing the VM to resume operation before any VM memory is loaded into physical memory, and then loading VM memory into physical memory on demand, as the VM memory is accessed during the operation of the VM. Using this “lazy” approach to restoring VM memory, although the VM resumes operation immediately, the VM may initially seem unresponsive to a user of the VM.

Embodiments of this invention generally relate to loading some nonempty proper subset of VM memory pages into physical memory, resuming operation of the VM, and then loading additional VM memory pages into physical memory. For example, a fixed amount or a fixed percentage of VM memory can be prefetched into physical memory before resuming operation of the VM, and then the rest of the VM memory can be loaded into physical memory after the VM has resumed operation, such as in response to attempted accesses to the memory.

Unlike other virtualization overheads which are measured in CPU (“central processing unit”) clock cycles, the time required to restore a Virtual Machine (“VM”) from a snapshot or checkpoint on disk is typically measured in tens of seconds. Attempts to hide this latency with “lazy” restore techniques (in which users may interact with a VM before the restore is complete) may cause disk-thrashing when the guest accesses physical memory that has not been prefetched.

To improve the performance of restoring a VM, three techniques have been tested: reversed page walking and prefetching; special zero page handling; and working set prefetching. Prefetching from the top of physical memory may offer performance improvements for a Linux guest (i.e. when a VM is loaded with a Linux operating system (“OS”)). Special-casing zero pages may offer slight improvements, but, based on the testing that was performed, the most apparent speedup is achieved by prefetching the guest's working set.

A “working set” of memory pages in a computer system has a well-understood meaning. For example, the book “Modern Operating Systems”, second edition, by Andrew S. Tanenbaum, at page 222, indicates “[t]he set of pages that a process is currently using is called its working set” (citing a couple of articles by P. J. Denning). In the context of a virtualized computer system, a working set of memory pages for a VM may be considered to be memory pages that are in use by all processes that are active within a VM, such that the VM's working set includes all of the working sets for all of the active processes within the VM.

Embodiments of this invention may be implemented in the Workstation virtualization product, from VMware, Inc., for example, and the testing described herein was performed using the Workstation product. The Workstation product allows users to suspend and snapshot (or checkpoint) running VMs. Suspend/resume is like a “pause” mechanism, the state of the VM is saved before the VM is stopped. Later, a user may resume the VM, and its saved state is discarded. When a user wishes to maintain the saved state, e.g., to allow rolling back to a known-good configuration, he may snapshot the VM and assign a meaningful name to the state. Later, he can restore this snapshot as many times as he wants, referring to it by name.

The most expensive part (in terms of time) of a resume or restore is paging-in all of the VM's physical memory (referred to above as the VM memory) from the saved memory image on disk. There are at least three ways a page can be fetched from a checkpoint memory file. A “lazy” implementation may prefetch a specific quantity of VM memory or a specific percentage of the total VM memory before starting up the VM. Pages may be fetched in blocks of 64 pages, or using some other block size, to amortize the cost of accessing the disk. After prefetching, the VM is started. A background page walker thread may scan memory linearly, bringing in the rest of the memory from disk. Any pages the VM accesses that have not been prefetched or paged-in by the page walker are brought in on-demand.

If lazy restore is disabled, an “eager” restore prefetches all VM memory prior to starting the VM. In the current Workstation product, eager restore performs better than lazy restore in many cases, but the improvements described below make lazy restores much more appealing, in many cases.

Our testing suggests that a VM becomes usable, meaning that software within the VM (including a “guest OS” and one or more “guest applications”, collectively referred to as “guest software”) responds quickly to user input, when the frequency of on-demand requests from the guest software reach a low threshold so that page requests caused by user interaction can be handled quickly. One goal of the testing discussed below is to reduce the number of disk accesses by reducing the number of on-demand requests from the guest software.

One approach to restoring state information to a VM that was tested involves prefetching some amount of VM memory at the top of memory (i.e. memory pages with higher memory addresses), resuming operation of the VM, and then using a background page walker thread to load the rest of the VM memory into physical memory, continuing the loading of VM memory at the higher addresses and progressing toward the lower addresses. From memory testing, it appears that the Red Hat Enterprise Linux 4 OS (“RHEL4”), from Red Hat, Inc., allocates higher memory addresses first. Thus, a simple technique that may improve the restoration time for a checkpointed VM is to prefetch higher memory first and have the page walker scan memory backwards. However, this technique did not appear to have any affect on the restoration time when the VM is running a Windows OS from Microsoft Corporation.

Compared to prefetching from low address to high, prefetching from the top of memory brings in more blocks that the RHEL4 guest will use during the lazy restore, reducing the number of on-demand requests. The page walker still fetches 64-page blocks, as described above, but requests the blocks in decreasing block number order.

Another technique that was tested involves handling memory pages that contain all zeroes. An offline snapshot file analysis showed that a VM's memory may contain many zero pages. To avoid file access for these zero pages, the checkpoint code can scan every page as it is saved to the snapshot file and store a bitmap of the zero pages in a file. During restore, if the VM requests a zero page, the page need not be fetched. The page can simply be mapped in from a new paging file which may be initialized with zero pages. When a request is received for a non-zero page, a 64-page block may be fetched, but only non-zero pages from the block are copied into the new paging file to avoid overwriting memory the VM has since modified.

Depending on the implementation, this technique for trying to avoid disk accesses for zero pages may speed up VM restores at the expense of scanning for zero pages at snapshot time. To avoid this overhead, zero pages could be identified in other ways, such as by a page sharing algorithm, such as described in U.S. Pat. No. 6,789,156 (“Content-based, transparent sharing of memory units”), which is also assigned to VMware.

While the heuristics described above can be helpful, testing suggests that better performance may be realized if the snapshot infrastructure can estimate the working set of the VM. Then, only pages in the working set need be prefetched. Prefetch time may increase over some other approaches, but user actions, page walking, and guest memory accesses will likely no longer contend for the disk. Of course, in cases where the guest working set is small, the prefetch time may actually be decreased. One technique that was tested involved a trace-based scheme that works well for snapshot/restore functionality. As described below, however, suspend/resume functionality may not be able to use the same tracing technique. Other techniques may be used for suspend/resume functionality, however, including an access bit scanning technique that is also described below.

A user generally expects the state of a snapshotted VM to correspond to the moment the user initiates the snapshot. To achieve this, while letting the user continue to use the VM, a lazy snapshot implementation may install traces to capture writes to memory by guest software that occur while memory is being saved to disk (the use of memory traces has also been described in previously filed VMware patents and patent applications, including U.S. Pat. No. 6,397,242, “Virtualization System Including a Virtual Machine Monitor for a Computer with a Segmented Architecture”). Memory pages that have been written by the guest since their initial saving must be updated in the checkpoint file to maintain consistency. For example, the '897 patent referenced above describes such an approach using a “copy-on-write” or “COW” technique.

This lazy snapshot implementation can be modified to obtain an estimate of the working set of the VM by replacing the write traces with read/write traces (i.e. traces that are triggered by a read or a write access). A bitmap can be added to the checkpoint file that indicates if a page was accessed by the guest (either read or written) during the lazy snapshot period or if a block of pages contains such a page. If a read trace fires (or is triggered), a bit corresponding to this page is set in the bitmap. If the trace is for a write, then the corresponding bit is set in the bitmap and the memory page (or the block containing the memory page) is written out to the snapshot file as in the implementation described above.

To restore the snapshot, the bitmap may be consulted and blocks containing the specified working set (or just the memory pages themselves) may be prefetched into memory. When the VM begins to execute, it should generally access roughly the same memory for which accesses were detected during the lazy snapshot phase. This memory has been prefetched, so costly disk accesses may be avoided at execution time, generally providing a more responsive user experience.

In existing VMware products, suspending does not happen in a lazy fashion like snapshotting, so write traces are not installed. Thus, adding read/write traces to record the working set of a VM could substantially extend the time required to suspend the VM. Accordingly, a different approach may be used to estimate a working set for the VM, such as using a background thread to scan and clear access bits (A-bits) in the shadow page tables.

A non-zero A-bit corresponds to a “hot” page (within a given scan interval). By storing hot page addresses in the working set bitmap and consulting the bitmap at resume time, the memory likely to be most useful can be prefetched prior to resuming operation of the VM.

The experimentation and testing described above led, in part, to various embodiments of the invention, as further described below.

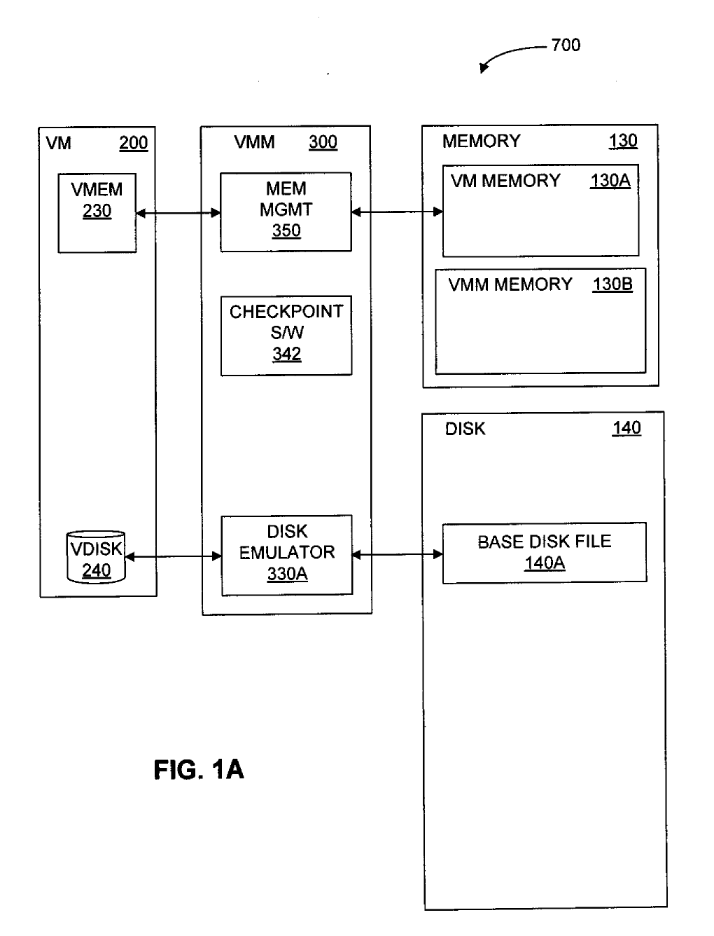

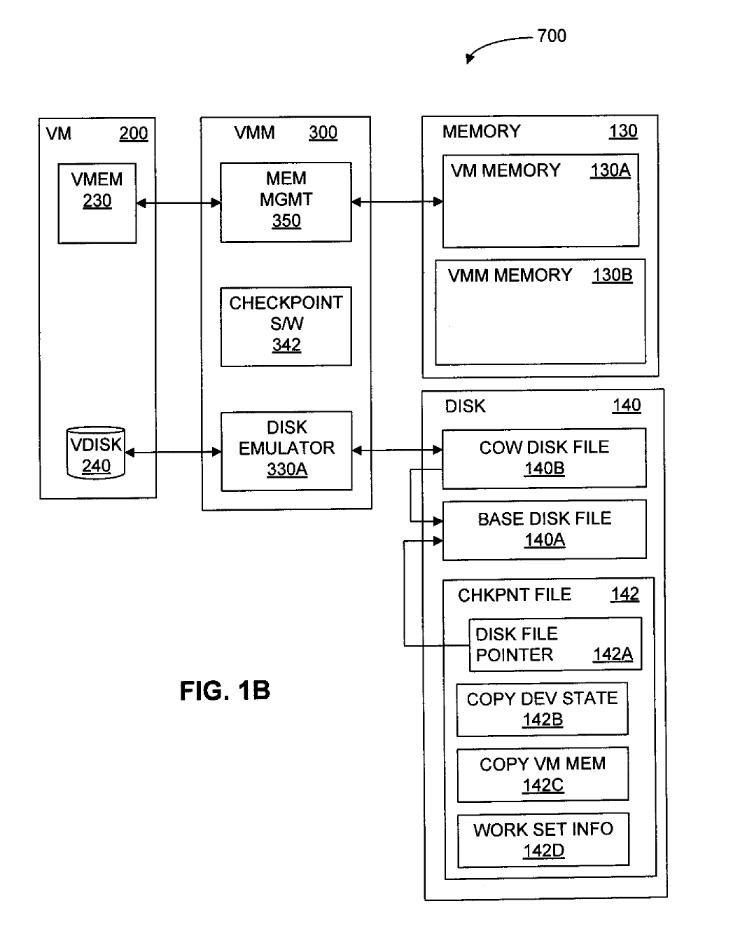

This invention may be implemented in a wide variety of virtual computer systems, based on a wide variety of different physical computer systems. As described above, the invention may also be implemented in conventional, non-virtualized computer systems, but this description will be limited to implementing the invention in a virtual computer system for simplicity. Embodiments of the invention are described in connection with a particular virtual computer system simply as an example of implementing the invention. The scope of the invention should not be limited to or by the exemplary implementation. In this case, the virtual computer system in which a first embodiment is implemented may be substantially the same as virtual computer systems described in previously-filed patent applications that have been assigned to VMware, Inc. In particular, the exemplary virtual computer system of this patent may be substantially the same as a virtual computer system described in the '897 patent. In fact, FIGS. 1A and 1B use the same reference numbers as were used in the '897 patent, and components of this virtual computer system may be substantially the same as correspondingly numbered components described in the '897 patent, except as described below.

FIG. 1A illustrates a general virtualized computer system 700 implementing an embodiment of this invention. The virtualized computer system 700 includes a physical hardware computer system that includes a memory (or other non-persistent storage) 130 and a disk drive (or other persistent storage) 140. The physical hardware computer system also includes other standard hardware components (not shown), including one or more processors (not shown). The virtualized computer system 700 includes virtualization software executing on the hardware, such as a Virtual Machine Monitor (“VMM”) 300. The virtualized computer system 700 and the virtualization software may be substantially the same as have been described in previously-filed patent applications assigned to VMware, Inc. More generally, because virtualization functionality may be implemented in hardware, firmware, or by other means, the term “virtualization logic” may be used instead of “virtualization software” to more clearly encompass such implementations, although the term “virtualization software” will generally be used in this patent. As described in previously-filed VMware patent applications, the virtualization software supports operation of a virtual machine (“VM”) 200. The VM 200 may also be substantially the same as VMs described in previously-filed VMware patent applications. Thus, the VM 200 may include virtual memory 230 and one or more virtual disks 240.

At a high level, FIG. 1A illustrates the VM 200, the VMM 300, the physical memory 130 and the physical disk 140. The VM 200 includes the virtual memory 230 and the virtual disk 240. The virtual memory 230 is mapped to a portion of the physical memory 130 by a memory management module 350 within the VMM 300, using any of various known techniques for virtualizing memory. The virtualization of the physical memory 130 is described in the '897 patent. The portion of the physical memory 130 to which the virtual memory 230 is mapped is referred to as VM memory 130A. The physical memory 130 also includes a portion that is allocated for use by the VMM 300. This portion of the physical memory 130 is referred to as VMM memory 130B. The VM memory 130A and the VMM memory 130B each typically comprises a plurality of noncontiguous pages within the physical memory 130, although either or both of them may alternatively be configured to comprise contiguous memory pages. The virtual disk 240 is mapped to a portion, or all, of the physical disk 140 by a disk emulator 330A within the VMM 300, using any of various known techniques for virtualizing disk space. As described in the '897 patent, the disk emulator 330A may store the virtual disk 240 in a small number of files on the physical disk 140. A physical disk file that stores the contents of the virtual disk 240 is represented in FIG. 1A by a base disk file 140A. Although not shown in the figures for simplicity, the disk emulator 330A also has access to the VM memory 130A for performing data transfers between the physical disk 140 and the VM memory 130A. For example, in a disk read operation, the disk emulator 330A reads data from the physical disk 140 and writes the data to the VM memory 130A, while in a disk write operation, the disk emulator 330A reads data from the VM memory 130A and writes the data to the physical disk 140.

FIG. 1A also illustrates a checkpoint software unit 342 within the VMM 300. The checkpoint software 342 comprises one or more software routines that perform checkpointing operations for the VM 200, and possibly for other VMs. For example, the checkpoint software may operate to generate a checkpoint, or it may cause a VM to begin executing from a previously generated checkpoint. The routines that constitute the checkpoint software may reside in the VMM 300, in other virtualization software, or in other software entities, or in a combination of these software entities, depending on the system configuration. As with virtualization logic, functionality of the checkpoint software 342 may also be implemented in hardware, firmware, etc., so that the checkpoint software 342 may also be referred to as checkpoint logic. Portions of the checkpoint software may also reside within software routines that also perform other functions. For example, one or more portions of the checkpoint software may reside in the memory management module 350 for performing checkpointing functions related to memory management, such as copy-on-write functions. The checkpoint software 342 may also or alternatively comprise a stand-alone software entity that interacts with the virtual computer system 700 to perform the checkpointing operations. Alternatively, the checkpoint software 342 may be partially implemented within the guest world of the virtual computer system. For example, a guest OS within the VM 200 or some other guest software entity may support the operation of the checkpoint software 342, which is primarily implemented within the virtualization software. The checkpoint software may take any of a wide variety of forms. Whichever form the software takes, the checkpoint software comprises the software that performs the checkpointing functions described in this application.

FIG. 1A shows the virtual computer system 700 prior to the generation of a checkpoint. The generation of a checkpoint may be initiated automatically within the virtual computer system 700, such as on a periodic basis; it may be initiated by some user action, such as an activation of a menu option; or it may be initiated based on some other external stimulus, such as the detection of a drop in voltage of some power source, for example.

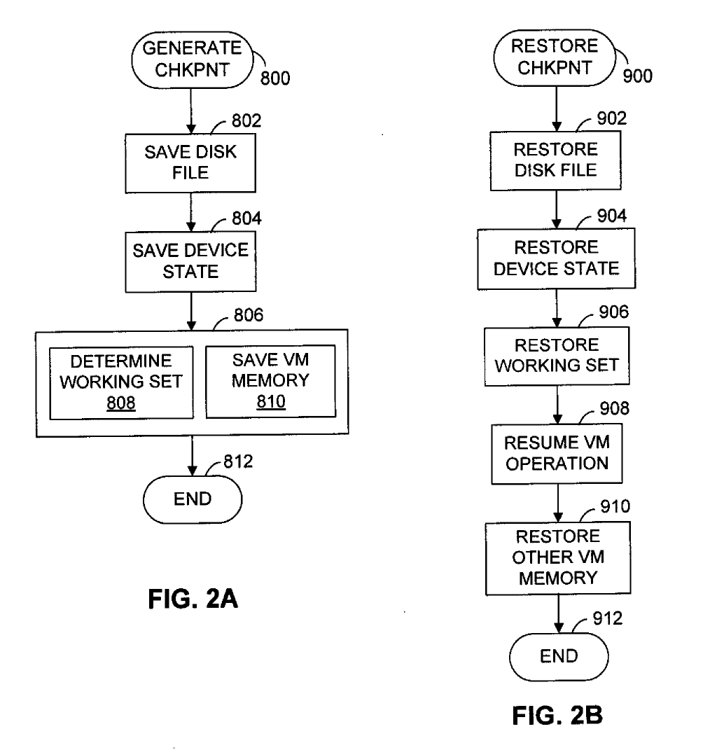

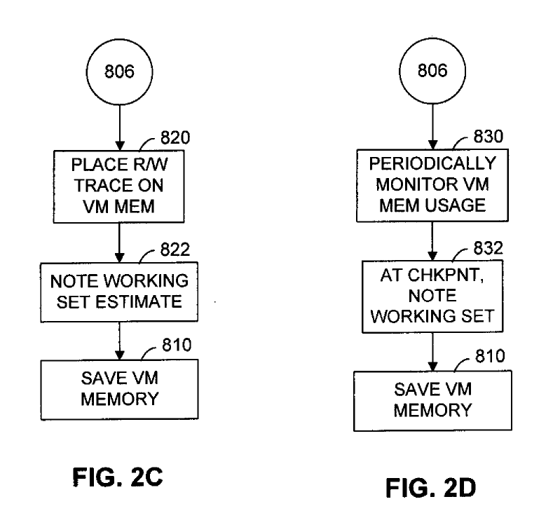

Once a checkpoint generation is initiated, the checkpoint software 342 begins running as a new task, process or thread within the virtual computer system, or the task becomes active if it was already running. The checkpoint software is executed along with the VM 200 in a common multitasking arrangement, and performs a method such as generally illustrated in FIG. 2A to generate the checkpoint. FIG. 1B illustrates the general state of the virtual computer system 700 at the completion of the checkpoint. The method of FIG. 2A for generating a checkpoint will now be described, with reference to FIG. 1B.

FIG. 2A begins at a step 800, when the operation to generate a checkpoint is initiated. Next, at a step 802, the state of the disk file 140A is saved. This step may be accomplished in a variety of ways, including as described in the '897 patent. For example, as illustrated in FIG. 1B, a copy-on-write (COW) disk file 140B may be created on the disk drive 140 referencing the base disk file 140A. Techniques for creating, using and maintaining COW files are well known in the art. The checkpoint software 342 changes the configuration of the disk emulator 330A so that the virtual disk 240 is now mapped to the COW disk file 140B, instead of the base disk file 140A. Also illustrated in FIG. 1B, a checkpoint file 142 may be created on the disk 140, and a disk file pointer 142A may be created pointing to the base disk file 140A.

Next, at a step 804, the device state for the VM 200 is saved. This step may also be accomplished in a variety of ways, including as described in the '897 patent. As illustrated in FIG. 1B, for example, the device state may be stored in the checkpoint file 142, as a copy of the device state 142B.

Next, at a compound step 806, two primary tasks are performed. As indicated at a step 808, one or more memory pages that are accessed around the time of the checkpointed state are identified as a set of “active memory pages”, where the set of active memory pages is a nonempty proper subset of the set of VM memory pages. In some embodiments, this set of active memory pages may constitute a “working set” of memory pages, or an estimate of a working set. This step may also be accomplished in a variety of ways, some of which will be described below. Some indication of the set of active memory pages may be saved in some manner for use when the checkpoint is restored, as described below. For example, FIG. 1B shows working set information 142D being saved to the checkpoint file 142. This information about the active memory pages may be saved in a variety of formats, including in a bitmap format or in some other “metadata” arrangement.

Also, at a step 810, within the compound step 806, the VM memory 130A is saved. Again, this step may be accomplished in a variety of ways, including as described in the '897 patent. As illustrated in FIG. 1B, for example, the VM memory 130A may be saved to the checkpoint file 142 as a copy of the VM memory 142C. After the compound step 806, the method of FIG. 2A ends at a step 812.

Although FIG. 2A shows the steps 802, 804 and 806 in a specific order, these steps can be performed in a variety of different orders. These steps are actually generalized steps for checkpointing a VM. As described in connection with FIG. 3A of the '897 patent, for example, these generalized steps may be performed by a larger number of smaller steps that can be arranged in a variety of different orders.

Embodiments of this invention involve using the information determined at step 808 of FIG. 2A during the restoration of a checkpointed VM, in an effort to speed up the process of getting the restored VM to a responsive condition. FIG. 2B illustrates a generalized method, according to some embodiments of this invention, for restoring a checkpointed VM and resuming operation of the VM. FIG. 2B may be viewed as a generalized version of FIG. 3G of the '897 patent, except with modifications for implementing this invention, as will be apparent to a person of skill in the art, based on the following description.

The method of FIG. 2B begins at an initial step 900, when a determination is made that a checkpointed VM is to be restored. This method can be initiated in a variety of ways, such as in response to a user clicking on a button to indicate that a checkpointed VM should be restored, or in response to some automated process, such as in response to management software detecting some error condition during the operation of another VM or another physical machine.

Next, at a step 902, the checkpointed disk file is restored. This step may be accomplished in a variety of ways, including as described in the '897 patent. Referring to FIG. 1B, for just one example, the checkpoint software 342 could just change the configuration of the disk emulator 330A so that the virtual disk 240 again maps to the base disk file 140A, although this would then cause the checkpointed disk file to be changed, so that the entire checkpointed state of the VM would no longer be retained after the VM resumes execution.

Next, at a step 904, the device state is restored from the checkpoint. Again, this step may be accomplished in a variety of ways, including as described in the '897 patent. Thus, referring to FIG. 1B, the copy of the device state 142B is accessed, and all of the virtualized registers, data structures, etc. that were previously saved from the execution state of the VM 200 are now restored to the same values they contained at the point that the checkpoint generation was initiated.

Next, at a step 906, one or more of the active memory pages that were identified at step 808 of FIG. 2A are loaded back into memory. Thus, referring again to FIG. 1B as an example, the working set information 142D may be used to determine the set of active memory pages from the set of all VM memory pages stored in the copy of the VM memory 142C. One or more of the active memory pages may then be loaded from the copy of the VM memory 142C into physical memory 130, as a proper subset of VM memory 130A. In different embodiments of the invention, different sets of active memory pages may be loaded into memory. In some embodiments, the active memory pages constitute a working set of memory pages, or an estimated working set, and the entire set of active memory pages is loaded into memory at the step 906. Also in some embodiments, only memory pages that have been identified as active memory pages in connection with the checkpointing of a VM are loaded into memory during the step 906, before the VM resumes operation, while, in other embodiments, one or more VM memory pages that are not within the set of active memory pages may also be loaded into memory, along with the one or more active memory pages. Thus, in some embodiments, the only VM memory pages that are loaded into physical memory before operation of the VM is resumed are memory pages that have previously been identified as active memory pages in connection with the checkpointing of a VM.

Thus, in different embodiments of the invention, the set of memory pages loaded into physical memory before operation of the VM resumes may constitute: (a) one or more of the previously identified active memory pages, but not all of the previously identified active memory pages, and no VM memory pages that have not been identified as active memory pages (i.e. a nonempty proper subset of the active memory pages, and nothing else); (b) all of the previously identified active memory pages, and no other VM memory pages; (c) a nonempty proper subset of the active memory pages, along with one or more VM memory pages that are not within the set of active memory pages, but not all VM memory pages that are not within the set of active memory pages (i.e. a nonempty proper subset of VM memory pages that are not within the set of active memory pages); and (d) all of the previously identified active memory pages, along with a nonempty proper subset of VM memory pages that are not within the set of active memory pages. Step 906 of FIG. 2B represents the loading into physical memory of all of the VM memory pages that are loaded before operation of the VM resumes and only the VM memory pages that are loaded before operation of the VM resumes

Also, in different embodiments of the invention, determining which memory pages and how many memory pages are loaded into physical memory at step 906 can depend on a variety of factors. As just a couple of examples, a specific, predetermined number of VM memory pages can be loaded into memory at step 906, or a specific, predetermined proportion of the total VM memory pages can be loaded into memory at step 906. In other embodiments, which memory pages and how many memory pages are loaded into physical memory can depend on other variable factors such as available time or disk bandwidth.

Next, at a step 908, operation of the VM is resumed. Referring again to FIG. 1B, operation of the VM 200 is resumed.

Next, at a step 910, additional VM memory pages, which were not loaded into memory in step 906, are loaded into memory after operation of the VM resumes. For example, referring again to FIG. 1B, additional memory pages from the copy of VM memory 142C are loaded into physical memory 130, as part of VM memory 130A. In some embodiments, all VM memory pages that were saved in connection with the checkpoint and that were not loaded into memory during step 906 are loaded into memory in step 910. In other embodiments, some of which will be described below, not all remaining VM memory pages are loaded into memory in step 910. The order in which other VM memory pages are loaded into memory can vary, depending on the particular embodiment and possibly depending on the particular circumstances at the time step 910 is performed. In some embodiments, for example, if not all active memory pages were loaded into memory at step 906, then the remainder of the active memory pages may be loaded into memory first, at step 910, before loading any VM memory pages that are not within the set of active memory pages. The loading of memory pages may be handled in different manners too, depending on the embodiment and the circumstances. For example, some or all remaining pages that are loaded into memory may be loaded on demand, in response to an attempted access to the respective memory pages. Also, some or all remaining pages that are loaded into memory may be loaded by a background page walker thread scanning memory linearly. Some embodiments may use a combination of the background page walker and the on demand loading. Other embodiments may use some other approach.

After step 910, the method of FIG. 2B ends at step 912.

Referring again to FIG. 2A, different embodiments of the invention may use different methods for performing the compound step 806. FIG. 2C illustrates a first method that may be used to perform step 806 and FIG. 2D illustrates a second such method. As described above, these and other methods for the compound step 806 may generally be performed in any order relative to steps 802 and 804 of FIG. 2A. Thus, these methods may generally be performed before or after the disk file is saved at step 802, and before or after the device state is saved at step 804. Different embodiments of the invention may, more particularly, employ different methods for performing step 808 to determine or estimate a working set, or otherwise determine a set of one or more active memory pages.

Referring next to FIG. 2C, the illustrated method first proceeds to a step 820, where a read/write trace is placed on each page of the VM memory 130A. Note that, as illustrated in FIG. 2A, this step 820 is performed after the generation of a checkpoint has been initiated. As described above, write traces may be placed on VM memory pages during lazy checkpointing anyways, so step 820 would generally only involve making the traces read/write traces in lazy checkpointing implementations. Referring to the checkpointing methods described in the '897 patent, the copy-on-write technique also involves write traces that could be changed to read/write traces. In this manner, during the checkpointing operation, after step 820, any access to VM memory causes a memory trace to be triggered.

Next, at a step 822, whenever one of the read/write traces on VM memory is triggered, the VM memory page that is accessed is identified as, or determined to be, an active memory page. Information identifying each of the active memory pages may be saved, such as to disk, after each new active memory page is identified, or after the entire set of active memory pages is identified, such as by writing appropriate data to a bitmap in the working set information 142D. In addition to noting active memory pages in response to the triggering of read/write traces, other actions may also need to be taken in response to the triggering of the read/write traces, such as the copy-on-write action described in the '897 patent in response to a write to VM memory. Next, at step 810, the VM memory is saved as described above.

Now referring to FIG. 2D, the method first proceeds to a step 830, where usage of VM memory is monitored during the operation of the VM, before a checkpoint is initiated on the VM. This step may also be performed in a variety of ways in different embodiments. For example, some embodiments may involve scanning the access bits of VM memory pages in shadow page tables from time to time. For example, all access bits for VM memory pages can be cleared, and then, some time later, all access bits for the VM memory pages can be scanned to determine which VM memory pages have been accessed since the access bits were cleared. This process of clearing and later scanning access bits can be repeated from time to time, periodically or based on any of a variety of factors, so that a different set of accessed VM memory pages can be identified each time the process of clearing and later scanning the access bits is performed. Next, at a step 832, when a checkpoint is initiated, the set of active memory pages can be determined, for example, based on the VM memory pages that have been accessed since the last time the access bits were cleared. Information about this set of active memory pages can then be saved as described above, in connection with step 822 of FIG. 2C. Next, at step 810, the VM memory is saved as described above.

Referring again to step 830 of FIG. 2D, in other embodiments, instead of monitoring usage of VM memory before a checkpoint is initiated, VM memory usage can be monitored briefly after the checkpoint is initiated. For example, the technique of clearing and subsequent scanning of access bits of VM memory pages described in the previous paragraph can begin after the checkpoint has been initiated, and the cycle of clearing and scanning access bits can be performed one or more times to estimate a working set or otherwise identify a set of active memory pages.

Embodiments of this invention can also be implemented in hardware platforms that utilize recent or future microprocessors that contain functionality intended to support virtualization, such as processors incorporating Intel Virtualization Technology (Intel VT-x™) by Intel Corporation and processors incorporating AMD Virtualization (AMD-V™) or Secure Virtual Machine (SVM) technology by Advanced Micro Devices, Inc. Processors such as these are referred to herein as “virtualization-supporting processors”. Thus, for example, instead of clearing and monitoring access bits in shadow page tables, embodiments of this invention can employ the clearing and monitoring of access bits in nested page tables or extended page tables, which will be referred to collectively herein as “virtualization-supporting page tables”.

Once the memory pages that will constitute the set of active memory pages are determined, information identifying the active memory pages is saved in some manner, such as to a disk drive or other persistent storage. This information may be stored in a variety of different ways in different embodiments of the invention. For example, referring to FIG. 1B, a bit map may be stored as the working set information 142D, within the checkpoint file 142. The information may alternatively be stored as some other form of “metadata”. Also, the information may be “stored” in some implicit manner. For example, referring again to FIG. 1B, instead of storing all VM memory pages in the single copy of VM memory 142C, the VM memory pages can be stored in two groups, possibly in two separate files, a first group consisting of all active memory pages and a second group consisting of all other VM memory pages. Then, at step 906 of FIG. 2B, the first group can be accessed, sequentially, for example, to load active memory pages into memory, without a separate reference to information indicating the set of active memory pages. Also, in some embodiments, the first group can be stored on a separate physical disk from the rest of the checkpointed state, so that active memory pages can be loaded in parallel with the rest of the checkpoint restoration process. Also, metadata may be stored along with the first group of VM memory pages to enable the virtualization software to determine appropriate memory mappings for these VM memory pages. For example, this metadata can be used to determine appropriate mappings from guest physical page numbers (GPPNs) to physical page numbers (PPNs), as those terms are used in the '897 patent.

As another alternative, instead of storing the VM memory pages in two separate groups, as described in the previous paragraph, all the VM memory pages can be stored generally from the “hottest” to the “coldest”, where a memory page is generally hotter than another if it has been accessed more recently. In addition to storing the VM memory pages in order, generally from hottest to coldest, metadata can also be stored mapping disk blocks to VM memory pages. The hottest memory pages can then be read from the disk sequentially into physical memory, and appropriate memory mappings can be installed. The set of “active memory pages” can then be defined as some set of memory pages that would be read out first. The set of memory pages that are loaded into memory before operation of the VM is resumed can again vary depending on the embodiment and/or the circumstances.

In addition to all the variations in all the different embodiments described above, other techniques may also be used to speed up the process of restoring a checkpointed VM. For example, the checkpoint file 142 can be compressed when saved to disk and decompressed when the checkpoint is restored. This may save some time during the restoration of the checkpointed VM, depending on the time saved by a reduced number of disk accesses and the time expended by the decompression process.

As described above, reading of all-zero memory pages from disk may be avoided in some situations, for example if metadata is stored along with a checkpoint, indicating which VM memory pages contain all zeroes. A similar approach may be used when some VM memory pages contain a simple pattern. Metadata can be used, for example, to identify VM memory pages with a common simple pattern, so that these VM memory pages can effectively be synthesized from the metadata.

What is claimed is:

1. A method for restoring state information in a virtual machine (“VM”) and resuming operation of the VM, the state information having been saved in connection with earlier operation of the VM, the state information for the VM comprising virtual disk state information, device state information and VM memory state information, the method comprising:
restoring access to a virtual disk for the VM;
restoring device state for the VM;
loading into physical memory one or more memory pages from a previously identified set of active memory pages for the VM, the set of active memory pages having been identified as being recently accessed prior to or during the saving of the state information of the VM, the set of active memory pages comprising a proper subset of the VM memory pages;
after the one or more memory pages from the previously identified set of active memory pages have been loaded into physical memory, resuming operation of the VM; and
after resuming operation of the VM, loading into physical memory additional VM memory pages.

2. The method of claim 1, wherein the previously identified set of active memory pages constitutes an estimated working set of memory pages.

3. The method of claim 2, wherein the one or more memory pages that are loaded into physical memory before operation of the VM is resumed constitute the estimated working set of memory pages.

4. The method of claim 1, wherein access to the virtual disk is restored before any VM memory pages are loaded into physical memory.

5. The method of claim 1, wherein device state for the VM is restored before any VM memory pages are loaded into physical memory.

6. The method of claim 1, wherein access to the virtual disk is restored and device state for the VM is restored before any VM memory pages are loaded into physical memory.

7. The method of claim 1, wherein after resuming operation of the VM, all of the remaining VM memory pages are loaded into physical memory.

8. The method of claim 1, wherein the set of active memory pages for the VM is identified by the following steps:
upon determining that state information for the VM is to be saved, placing read/write traces on all VM memory pages that are in physical memory;
while state information for the VM is being saved, allowing the VM to continue operating and detecting accesses to VM memory pages through the read/write traces; and
identifying VM memory pages that are accessed while state information is being saved as active memory pages.

9. The method of claim 8, wherein all memory pages that are accessed while state information is being saved are identified as active memory pages.

10. The method of claim 1, wherein the set of active memory pages for the VM is identified by the following steps:
(a) upon determining that state information for the VM is to be saved, clearing access bits in page tables for all VM memory pages that are in physical memory;
(b) allowing the VM to continue operating and detecting accesses to VM memory pages by monitoring the access bits in the page tables for the VM memory pages; and
(c) identifying VM memory pages that are accessed after the access bits were cleared in step (a) as active memory pages.

11. The method of claim 10, wherein all memory pages that are accessed after the access bits were cleared in step (a) are identified as active memory pages.

12. The method of claim 1, wherein the set of active memory pages for the VM is identified by the following steps:
on a continuing basis prior to determining that state information for the VM is to be saved, detecting accesses to VM memory pages; and
upon determining that state information for the VM is to be saved, based on the detected accesses to VM memory pages, identifying a set of recently accessed VM memory pages as the set of active memory pages.

13. The method of claim 12, wherein accesses to VM memory pages are detected on an ongoing basis by repeatedly clearing and monitoring access bits in one or more shadow page tables.

14. The method of claim 12, wherein accesses to VM memory pages are detected on an ongoing basis by repeatedly clearing and monitoring access bits in one or more virtualization-supporting page tables.

15. A computer program product embodied in a computer-readable medium, the computer program product performing a method for restoring state information in a virtual machine (“VM”) and resuming operation of the VM, the state information having been saved in connection with earlier operation of the VM, the state information for the VM comprising virtual disk state information, device state information and VM memory state information, the method comprising:
restoring access to a virtual disk for the VM;
restoring device state for the VM;
loading into physical memory one or more memory pages from a previously identified set of active memory pages for the VM, the set of active memory pages having been identified as being recently accessed prior to or during the saving of the state information of the VM, the set of active memory pages comprising a proper subset of the VM memory pages;
after the one or more memory pages from the previously identified set of active memory pages have been loaded into physical memory, resuming operation of the VM; and
after resuming operation of the VM, loading into physical memory additional VM memory pages.

16. The computer program product of claim 15, wherein the previously identified set of active memory pages constitutes an estimated working set of memory pages.

17. The computer program product of claim 16, wherein the one or more memory pages that are loaded into physical memory before operation of the VM is resumed constitute the estimated working set of memory pages.

18. The computer program product of claim 15, wherein access to the virtual disk is restored before any VM memory pages are loaded into physical memory.

19. The computer program product of claim 15, wherein device state for the VM is restored before any VM memory pages are loaded into physical memory.

20. The computer program product of claim 15, wherein access to the virtual disk is restored and device state for the VM is restored before any VM memory pages are loaded into physical memory.

21. The computer program product of claim 15, wherein after resuming operation of the VM, all of the remaining VM memory pages are loaded into physical memory.

22. The computer program product of claim 15, wherein the set of active memory pages for the VM is identified by the following steps:
upon determining that state information for the VM is to be saved, placing read/write traces on all VM memory pages that are in physical memory;
while state information for the VM is being saved, allowing the VM to continue operating and detecting accesses to VM memory pages through the read/write traces; and
identifying VM memory pages that are accessed while state information is being saved as active memory pages.

23. The computer program product of claim 22, wherein all memory pages that are accessed while state information is being saved are identified as active memory pages.

24. The computer program product of claim 15, wherein the set of active memory pages for the VM is identified by the following steps:
(a) upon determining that state information for the VM is to be saved, clearing access bits in page tables for all VM memory pages that are in physical memory;
(b) allowing the VM to continue operating and detecting accesses to VM memory pages by monitoring the access bits in the page tables for the VM memory pages; and
(c) identifying VM memory pages that are accessed after the access bits were cleared in step (a) as active memory pages.

25. The computer program product of claim 24, wherein all memory pages that are accessed after the access bits were cleared in step (a) are identified as active memory pages.

26. The computer program product of claim 15, wherein the set of active memory pages for the VM is identified by the following steps:
on a continuing basis prior to determining that state information for the VM is to be saved, detecting accesses to VM memory pages; and
upon determining that state information for the VM is to be saved, based on the detected accesses to VM memory pages, identifying a set of recently accessed VM memory pages as the set of active memory pages.

27. The computer program product of claim 26, wherein accesses to VM memory pages are detected on an ongoing basis by repeatedly clearing and monitoring access bits in one or more shadow page tables.

28. The computer program product of claim 26, wherein accesses to VM memory pages are detected on an ongoing basis by repeatedly clearing and monitoring access bits in one or more virtualization-supporting page tables.
